(19) United States
(12) Patent Application Publication
(10) Pub. No.: US 2025/0276930 A1
(43) Pub. Date: Sep. 4, 2025

(54) Mold Assembly for an IS Machine

(71) Applicant: Heye International GmbH, Obernkirchen (DE)

(72) Inventors: Benedikt Felgenhauer, Herford (DE); Jonas Ulbricht, Bad Eilsen (DE); Eckhard Möller, Obernkirchen (DE); Matthias Lunacek, Obernkirchen (DE)

(21) Appl. No.: 19/068,570

(22) Filed: Mar. 3, 2025

(30) Foreign Application Priority Data
Mar. 4, 2024 (DE) 10 2024 106 198.7

(51) Int. Cl. C03B 9/197

(52) U.S. Cl. CPC C03B 9/197

(57) ABSTRACT

A mold assembly for an IS machine includes a first row of mold halves and a second row of mold halves, wherein the mold halves of the two rows face one another and a mold half of the first row and a mold half of the second row are assigned to one another such that together they can form a closed mold, and a mold closing mechanism with which the mold halves of the first row and the mold halves of the second row can be brought together reversibly from a position of assigned mold halves that are at a distance from one another to a position in which assigned mold halves form a closed mold, wherein the mold closing mechanism has a first transfer device with which a force can be exerted on the mold halves of the first row to bring together the mold halves of the two rows, characterized in that primary compensators are arranged between the first transfer device and the mold halves of the first row, which are elastically deformable when the mold halves of the two rows are brought together. In this way, a mold assembly for an IS machine is provided which exhibits improved closing characteristics.

The present application is based upon and claims the right of priority to DE Patent Application No. 10 2024 106 198.7, filed Mar. 4, 2024, the disclosure of which is hereby incorporated by reference herein in its entirety for all purposes.

The invention is based on a mold assembly for an IS machine, having a first row of a plurality of mold halves arranged next to one another and a second row of a plurality of mold halves arranged next to one another, wherein the mold halves of the two rows face one another, and one mold half of the first row and one mold half of the second row are assigned to one another so that together they can form a closed mold, and a mold closing mechanism, with which the mold halves of the first row and the mold halves of the second row can be brought together reversibly from a position of mutually assigned mold halves that are at a distance from one another to a position in which the mutually assigned mold halves form a closed mold, wherein the mold closing mechanism has a first transfer device, by means of which a force can be exerted on the mold halves of the first rows for bringing together the mold halves of the two rows.

IS machines for manufacturing glass containers have been known from the prior art for decades. The function of an IS machine is typically as follows:

Glass is melted in a trough and fed through a channel (feeder channel). At the end of the feeder channel is a glass outlet (spout), in which the glass is homogenized by means of an agitator or a rotating tube. The tube is also used for metering the glass outflow. A plunger presses the glass out of the spout, wherein a portioned glass gob (droplet) is cut off by scissors when the plunger is withdrawn.

The cut-off gobs (droplets) are fed to a gob distributor in free fall. The gob distributor has the task of forwarding the gobs to the corresponding processing stations (individual sections, IS). A gob deflector is positioned over the gob distributor and prevents the gobs from being fed to the section if the latter is not in operation or if the gobs are not be loaded for other reasons. Channels lead from the gob distributor to the sections which guide the gobs to the preforms of the section. In the section a container is formed from the gob in a two-step process. In a first step on the preform side a pre-mold is formed from the gob. This molding step can be carried out either by pressing or blowing. This pre-mold is pivoted to the finished mold side using a transfer mechanism. It is blown there in a second step into its final form, thereby forming a container. In both steps of the process, the glass is cooled continuously so that it can be removed from the final mold in a dimensionally stable state. As the cooled surfaces of the glass container reheat from the inside, the container needs to continue to be cooled. This is performed on a depositing plate, onto which the containers are deposited after removal from the finished mold.

When the containers are being transported, the glass containers produced in the sections of an IS machine are transported from the depositing plate to a lehr. They are pushed onto a machine belt from the depositing plates of the sections and are usually pushed over onto a cross conveyor at a deflection corner. From the cross conveyor they are finally brought into the annealing lehr via a pusher.

With regard to the premolds and the finished molds, several mold halves are usually always arranged in a row. Closed molds are formed by bringing together two mold halves that are assigned to one another and are typically mirror-symmetrical. The mold halves are periodically moved towards and away from each other during the manufacturing process of the glass containers. When the mold halves are moved towards one another, several circumferentially closed cavities are created in which the glass forming process can take place. It is desirable for the mold halves to be brought together as tightly as possible in a form-fitting manner. The fact that a plurality of molds are formed simultaneously by bringing the mold halves together entails a certain degree of inaccuracy. It is thus a challenge to bring these mold halves together such that each individual closed mold formed in this way is tight and form-fitting. Due to the manufacturing tolerances of the mold halves and the mechanical action of the closing mechanism on the mold halves, some of the molds may already be closed, while other molds still have a gap between the mold halves. The closed molds can thus prevent further molds from closing completely. A certain number of molds may thus remain in the closed state with a gap which has a detrimental effect on the production process.

U.S. Pat. No. 7,024,887 B2 describes a method and a machine for the production of hollow glass articles. In this document, a mold holding mechanism is shown, which has two pivotable mold holder arms, which can be moved towards one another in the manner of tongs. Each of these two arms is provided with a single pre-mold holder and a double pre-mold holder. The pre-mold holder carries a single pre-mold half. The double pre-mold holder carries two pre-mold halves accordingly. The pre-mold holder and the double pre-mold holder are attached to a single mold holder arm on a compensation carrier, by which the pre-mold halves can be closed evenly and with a similar closing force. The pre-molds are mounted pivotably on the mold holders by means of a pin on the compensation carrier. A compensation carrier is therefore provided with which the pre-molds can be brought together evenly. The purpose of these compensation carriers is to regulate the different distances between the pre-mold halves which occur due to the tong-like position of the mold holder arms.

DE 21 18 132 B shows a drive for elements, e.g. pressing punches and molding tongs, of glass-processing machines, with a cam track movable relative to the respective element and a drive roller running along the cam track and connected to the element, wherein a servomotor is connected between the drive roller and the element.

From DE 26 09 651 C2 a molding tool is known of a machine for processing molten glass, having at least one divided mold central piece, which is suspended with play on a correspondingly divided actuating device movable transversely to its longitudinal axis and guided in the transverse direction by guide elements in two guide planes arranged at an axial distance from one another. In this case, the entire force for holding the molding center piece parts that belong together is exerted by the actuating device in only one plane and the line of action of the resulting holding force for each molding center piece part lies in the application plane. In addition, the line of action of the resulting push-on partial force of the relevant mold center piece part coincides at least approximately with the line of action of the resulting closing partial force.

CN 2 13 012 546 U describes a mold device, which includes a base, an assembly groove, a demolding structure, an air cylinder and a left mold body. The assembly groove is formed on one side of the upper end of the base. The demolding structures are arranged on both sides of the interior of the assembly groove. A first support frame is attached to one side of the upper end of the base, and a second support frame is attached to the other side of the upper end of the base. A support axle is mounted in a sliding manner on one side of the interior of the first support frame. A left mold body is attached to the end of the support axle leading away from the outer wall of the first support frame. A limiting spring is wound on one side of the surface of the support axle. A connecting plate is attached to the position on one side of the limiting spring on the surface of the support axle, and an air cylinder is mounted on the outer wall of one side of the connecting plate. A second support frame is attached to one side of the upper end of the base.

In combination with a split mold including first and second cooperating mold halves supported by common pivot or hinge devices to enable a movement of said mold halves between open and closed positions of the mold, a device known from U.S. Pat. No. 3,499,747 A includes the following: first and second similar connecting struts, the first ends of which are attached to the outer peripheral portions of the respective first and second mold halves at respective positions via similar first pivot means; first and second identical spring assemblies, each including at least one elongated, elastic and resilient spring module, wherein the first ends of these modules are connected to the second ends of the respective first and second connecting struts via similar second pivot means; and a device which can move back and forth in correspondence with the center of the common pivot devices and is securely connected to the second ends of the spring modules for transmitting respective reciprocating movements and moving the mold halves between the open and closed positions of the mold. During the mold closing process, the spring modules provide forces via the connecting struts that are substantially directly aligned with each other to hold the mold in its closed position.

The objective of the invention is to provide a mold assembly for an IS machine which exhibits improved closing characteristics.

This objective is achieved by the subject-matter of claim 1. Preferred developments are given in the subclaims.

According to the invention, a mold assembly for an IS machine is thus provided, having a first row of a plurality of mold halves arranged next to one another and a second row of a plurality of mold halves arranged next to one another, wherein the mold halves of the two rows face one another and in each case one mold half of the first row and one mold half of the second row are assigned to one another in such a way together that they can form a closed mold, and a mold closing mechanism, by means of which the mold halves of the first row and the mold halves of the second row can be reversibly brought together from a position of mutually assigned mold halves that are at a distance from one another to a position in which mutually assigned mold halves form a closed mold, the mold closing mechanism having a first transfer device, with which a force can be exerted on the mold halves of the first rows to bring the mold halves of the two rows together, characterized in that primary compensators are arranged between the first transfer device and the mold halves of the first row, which primary compensators are elastically deformable when the mold halves of the two rows are brought together.

Furthermore, according to the invention it is provided that the mold halves of the first row are each attached to a mold holder with the interposition of a secondary compensator, wherein the mold holders in turn are coupled to primary compensators for force transfer and the secondary compensators are also elastically deformable when the mold halves of the two rows are brought together. Preferably, the secondary compensators each have a plurality of individual compensators, so that the force transmitted to a respective mold half can be adjusted via the number of individual compensators. The individual compensators preferably consist of metallic omega springs.

The mold halves assigned to one another preferably together form a pre-mold or a finished mold. For a reliable operation of such pre-molds or finished molds it is advantageous if all of the mold halves close evenly and with a defined minimum force. However, due to manufacturing tolerances and different thermal expansions, it may occur that not all mold halves touch at the same time when closing. If the entire system were rigid, i.e. if no primary compensators were used, only the mold halves that touch first would close correctly. The other mold halves could then no longer touch one another. This is avoided by using primary compensators, as the primary compensators of the mold halves that touch first deform slightly more than those of the mold halves that touch later. Preferably, the primary compensators are in the form of metallic, milled and hardened parts, so that primary compensators are obtained made of a flexible material with very good recovery behavior and a defined spring constant.

Similar to the compensation of tolerances described above, the compensators compensate for the wear of the mold halves when they are closed. As soon as the old halves become worn at their parting line at different speeds or to different degrees, the mold halves have different closing times when brought together. As mentioned above, a correct closing of the individual molds could not be guaranteed in a rigid system. This is avoided by the flexibility of the primary compensators.

In principle, the first transfer device can be configured in different ways. According to a preferred development of the invention, the first transfer device has a crankshaft and the primary compensators are configured such that the crankshaft together with the primary compensators acts as a toggle lever with which a respective force can be exerted by the first transfer device to the mold halves of the first row. Preferably, the crankshaft can be driven by a connecting rod, wherein the connecting rod is preferably coupled to a servomotor via a worm gear. Even if a single crankshaft were sufficient in principle, according to a preferred further development of the invention, the first transfer device has two crankshafts with which a respective force can be exerted by the first transfer device on a respective mold half of the first row in two spaced-apart areas via respective primary compensators according to the toggle lever principle, so that a uniform force can be exerted on the mold halves without producing a tilting moment.

A toggle lever consists of at least two lever elements connected by joints. This principle makes it possible, according to the principle of the lever, to transform a long movement path with low tensile or compressive force into a short path with high force and vice versa, which is known as force amplification. The characteristic feature of the toggle lever is the continuous change in the ratio of force applied to force achieved during the movement. In parallel with this, the ratio of the primary to secondary stroke also changes, albeit in transverse proportion to the force: in a bent state the toggle lever offers a high travel ratio with a low force ratio. As the toggle lever is extended, the speed of the stroke decreases at a constant actuation speed, while the force increase significantly. In the fully extended state, the force transmitted by the toggle lever can therefore be very high.

According to a preferred development of the invention, the mold holders also have holding inserts for holding the mold halves and holding devices, with which the holding inserts can be fastened at different points on the mold holder. Since the force application points into the molds vary depending on the mold height, conventional closing mechanisms have mold holders of different heights, which transmit the force to the mold halves accordingly. Here it is necessary to have corresponding mold holders in stock for all mold heights used which results in high material and storage costs. In the preferred embodiment of the invention described here, holding inserts are provided for the mold halves, which can be adjusted variably in height. This makes it possible to ensure different mold sizes with only one mold carrier, which significantly reduces the variety of parts. Depending on the mold height, only one holding insert or two holding inserts are used, for example.

Preferably, at least one portion of the holding inserts is provided with a cooling air duct, through which cooling air can be supplied to a respective mold half. Cooling air is passed from cooling air ducts in the mold holder to a respective cooling air duct in a holding insert, from where the cooling air enters into cooling air ducts that extend into outer walls of the mold halves.

Previously, it was always said that the mold closing mechanism has a first transfer device. Preferably, however, the mold closing mechanism also has a second transfer device with which a force can be exerted on the mold halves of the second rows to bring the two rows together, whereby elastic primary compensators are also arranged between the second transfer device and the mold halves of the second row. When opening and closing the molds, preferably not only the first row of mold halves is moved. Rather, the second row of mold halves is also moved towards or away from the first row of mold halves for opening and closing. The preferred embodiments described above for the first row also apply to the second row. Moreover, a common servomotor and a common worm gear unit are preferably used for both rows.

The invention also relates to a use of a mold assembly described above, in which the transfer from the position of the assigned mold halves at a distance from one another to the position in which assigned mold halves form a closed mold is performed in less than 250 ms, preferably in less than 210 ms. The invention also relates to a use of a mold assembly described above, in which a force of at least 14 kN, preferably at least 20 kN, is transferred by the transfer device. Due to the rapid closing of the mold halves and the high force, with which they come together during such use, stress peaks occur which lead to increased wear in the whole kinematics. Due to the flexibility of the compensators these stress peaks are damped and wear is minimized.

By using the primary compensators as flexible elements in the drive train, it is possible due to their elasticity to move beyond the top dead center when closing the molds. As with the pistons of an internal combustion engine, the direction of movement of the molds is reversed after passing the dead center and they open again. This enables a uniform direction of rotation of the worm gear and the worm shaft so that these components are only loaded on one side which reduces wear and avoids backlash.

In the following, the invention is explained in more detail with reference to the drawings by way of a preferred exemplary embodiment.

In the drawings:

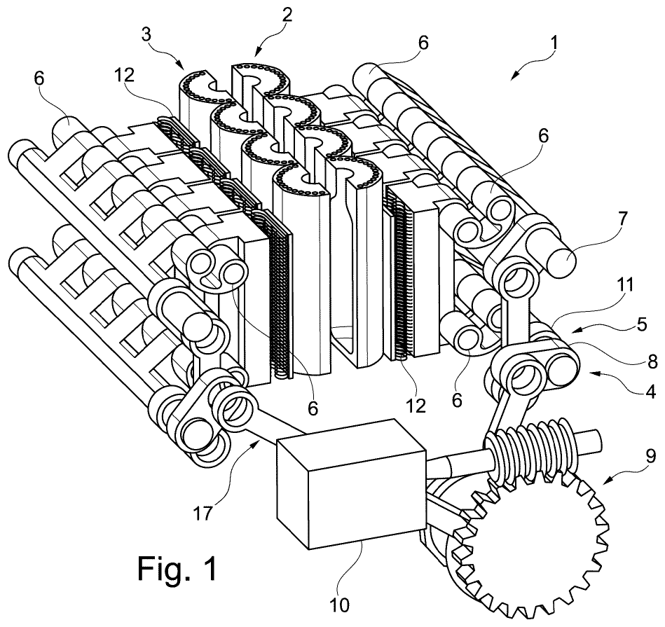

FIG. 1 shows schematically a mold assembly for an IS machine according to a preferred exemplary embodiment of the invention in a perspective view,

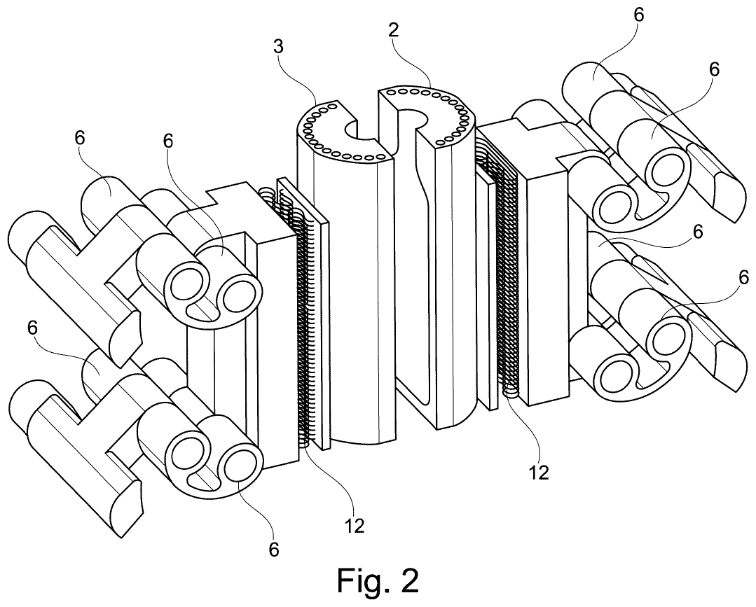

FIG. 2 shows schematically a detailed view of FIG. 1,

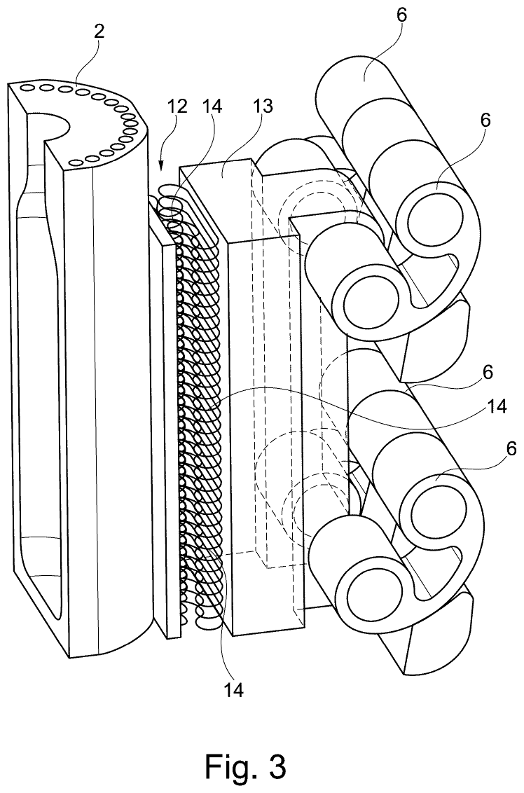

FIG. 3 shows schematically a further detailed view of FIG. 1,

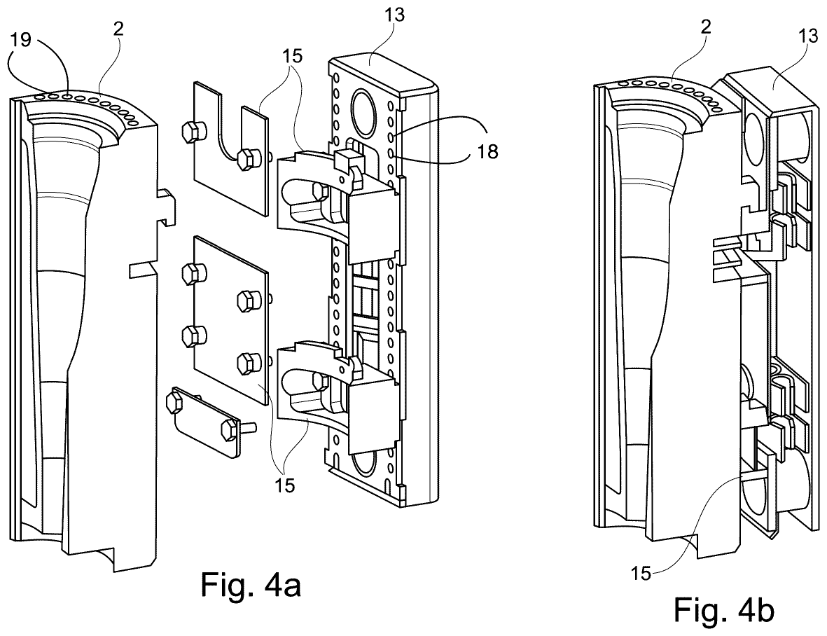

FIG. 4a shows schematically a mold holder from FIG. 1 in an exploded view and

FIG. 4b shows schematically the mold holder from FIG. 4a in the assembled state.

FIG. 1 shows schematically a mold assembly 1 for an IS machine according to a preferred exemplary embodiment of the invention in a perspective view. In the present case, the molds of the mold assembly 1 are finished molds of the IS machine. The mold assembly has a first row of mold halves 2 and a second row of mold halves 3, wherein the mold halves 2, 3 of the two rows face one another and one mold half 2 of the first row and one mold half 3 of the second row are assigned to one another such that together they can form a closed mold. Furthermore, a mold closing mechanism 4 is provided, with which the mold halves 2 of the first row and the mold halves 3 of the second row can be moved reversibly. In particular, the mold halves 2, 3 can be brought together from a position in which they are at a distance from each other and the mold formed by the two assigned mold halves 2, 3 is open to a position in which the assigned mold halves 2, 3 form a closed mold so that this can be used for a glass forming process.

The mold closing mechanism 4 is now configured such that it has a first transfer device 5, with which a force can be exerted on the mold halves 2 of the first row to bring the mold halves 2, 3 of the two rows together and a second transfer device 17, with which a force is exerted on the mold halves 3 of the second row to bring the mold halves 2, 3 of the two rows together, wherein primary compensators 6 are arranged between the first transfer device 5 and the mold halves 2 of the first row and also between the second transfer device 5 and the mold halves 3 of second row, which are elastically deformed when the mold halves 2, 3 of the two rows are brought together.

The first transfer device 5 has two crankshafts 7, 11, with which a respective force can be exerted by the first transfer device 5 on the mold halves 2 of the first row in two spaced apart areas via respective primary compensators 6 according to the toggle lever principle, namely on the one hand in an upper area and on the other hand in a lower area, so that no tilting effect occurs when the force is exerted on the mold halves 2. The same applies to the second transfer device 17 which acts on the mold halves 3 of the second row. The crankshafts 7, 11 can be driven via a connecting rod 8, wherein the connecting rod 8 is coupled to a servomotor 10 via a worm gear 9.

To ensure a reliable operating process when using the present finished molds, it is useful that all of the mold halves 2, 3 close uniformly and with a defined minimum force.

However, due to manufacturing tolerances and different thermal expansions, situations may arise in which not all pairs of mold halves 2, 3 close at the same time. Without the flexibility of primary compensators 6, i.e. in an inflexible system, only the mold halves 2, 3 that touch first would close correctly, while the others may no longer make contact with one another. The introduction of primary compensators 6 prevents this problem, by allowing the primary compensators 6 of the mold halves 2, 3 that come into contact first to deform more than those that come into contact later.

Furthermore, the primary compensators 6 also compensate for the wear of the mold halves 2, 3 during closing, similar to tolerance compensation. Different wear intensities at the parting lines of the mold halves 2, 3 lead to varying closing times. As already explained, the correct closing of all mold halves 2, 3 could not be ensured in an inflexible system. The use of primary compensators 6 avoids this problem due to their elasticity.

In particular, it can be seen from FIGS. 2 and 3 that the mold halves 2 of the first row are each attached to a mold holder 13 with the interposition of a further compensator, namely a secondary compensator 12, wherein the mold holders 13 are coupled in turn to primary compensators 6 for the transfer of force and the secondary compensators 12 can also be elastically deformed when the mold halves 2, 3 of the two rows are brought together. FIG. 3 shows that the secondary compensators 12 each have a plurality of individual compensators 14, so that the force transmitted to a respective mold half 2, 3 can be adjusted via the number of individual compensators 14. In the present case, the individual compensators 14 consist of metallic omega springs.

In particular, it can be seen from FIGS. 4a and 4b that the mold holders 13 have holding inserts 15 for holding the mold halves 2, 3 and 13 holding devices 16, with which the holding inserts 15 can be attached at different points on the mold holder 13. In conventional closing mechanisms, due to the varying heights of the molds and the corresponding force application points, mold holders of different size have to be used to adequately transfer the force to the mold halves. This requires a plurality of mold holders to be kept in stock for all possible mold heights, which in turn entails considerable material and storage costs. In the preferred variant of the invention described here, however, such holding inserts 15 are provided for the mold halves 2, 3, which can be adapted with regard to their installation position. As a result, different mold sizes can be used with just one mold holder 13 which considerably reduced the need to have a large selection of parts. Depending on the height of either of the mold halves 2, 3 either a single holding insert 15 or a plurality of holding inserts 15 are used. Cooling air is supplied from cooling air ducts 18 in the mold holder 13 through a holding insert 15 to a respective mold half 2, 3. Cooling air is therefore passed from the cooling air ducts 18 in the mold holder 13 to cooling air ducts 19, which extend in the outer walls of the mold halves 2, 3, in order to thus cool the mold halves 2, 3.

During the operation of the mold assembly 1 described here, the transition from the position in which the assigned mold halves 2, 3 are at a distance from one another to the position in which the assigned mold halves 2, 3 form a closed mold takes approximately 200 ms. In addition, the first transfer device 5 and the second transfer device 17 each transfer a force of 21 kN. The rapid pressing together of the mold halves 2, 3 with high intensity causes stress maxima, which result in increased abrasion in the whole movement mechanics. The elasticity of the compensators 6, 12 helps to alleviate these stress maxima and thus reduce the wear.

Due to their flexibility, the use of primary compensators 6 as adaptable components in the drive system makes it possible to move the molds beyond the highest point. Similar to the pistons of an internal combustion engine, the direction of movement of the mold halves 2, 3 reverses once this point has been passed and they open again. This allows a constant rotational movement of the worm wheel and the worm shaft of the worm gear 9, wherein these components are only stressed on one side. As a result, the degree of wear is reduced and the backlash is eliminated.

### LIST OF REFERENCE SIGNS

1 mold assembly
2 first row of mold halves
3 second row of mold halves
4 mold closing mechanism
5 first transfer device
6 primary compensators
7 crankshaft
8 connecting rod
9 worm gear
10 servomotor
11 second crankshafts
12 secondary compensator
13 mold holder
14 individual compensators
15 holding inserts
16 holding devices
17 second transfer device
18 cooling air ducts in the mold holder
19 cooling air ducts in a mold half

1. A mold assembly for an IS machine, comprising:
a first row of mold halves and a second row of mold halves,
wherein the mold halves of the two rows face one another and wherein a mold half of the first row and a mold half of the second row are assigned to one another such that together they can form a closed mold, and
a mold closing mechanism, by means of which the mold halves of the first row and the mold halves of the second row can be brought together reversibly from a position of assigned mold halves that are at a distance from one another to a position in which assigned mold halves form a closed mold,
wherein the mold closing mechanism comprises a first transfer device with which a force can be exerted on the mold halves of the first row for bringing together the mold halves of the two rows, and
wherein primary compensators are arranged between the first transfer device and the mold halves of the first row, which are elastically deformable when the mold halves of the two rows are brought together,
wherein the mold halves of the first row are secured to a mold holder with the interposition of a secondary compensator, wherein the mold holders are coupled in turn to primary compensators for the transfer of force, and the secondary compensators are also elastically deformable when the mold halves of the two rows are brought together.

2. The mold assembly according to claim 1, wherein the first transfer device includes a crankshaft and the primary compensators is configured such that the crankshaft acts together with the primary compensators as a toggle lever, with which a force can be exerted by the first transfer device on the mold halves of the first row.

3. The mold assembly according to claim 2, wherein the crankshaft can be driven via a connecting rod.

4. The mold assembly according to claim 3, wherein the connecting rod is coupled to a servomotor via a worm gear.

5. The mold assembly according to claim 2, wherein the first transfer device includes two crankshafts, with which a respective force can be exerted by the first transfer device on the mold halves of the first row in two spaced apart regions via respective primary compensators according to the toggle lever principle.

6. The mold assembly according to claim 1, wherein the secondary compensators each have a plurality of individual compensators and the force transferred to a respective mold half can be adjusted by the number of individual compensators.

7. The mold assembly according to claim 1, wherein the mold holders have holding inserts for holding the mold halves and holding devices with which the holding inserts can be secured at different points on the mold holder.

8. The mold assembly according to claim 7, wherein at least a portion of the holding inserts is provided with a cooling air duct through which cooling air can be supplied to a respective mold half.

9. The mold assembly according to claim 1, wherein the mold closing mechanism includes a second transfer device, with which a force can be exerted onto the mold halves of the second row for bringing together the mold halves of the two rows, wherein elastic primary compensators are arranged between the second transfer device and the mold halves of the second row.

10. The mold assembly according to claim 1, wherein mold halves assigned to one another together form a pre-mold or a finished mold.
